(19) United States
(12) Patent Application Publication
(10) Pub. No.: US 2026/0007968 A1
(43) Pub. Date: Jan. 8, 2026

(54) VIRTUAL OBJECT SWITCHING METHOD AND APPARATUS, STORAGE MEDIUM, AND ELECTRONIC APPARATUS

(71) Applicant: NETEASE (HANGZHOU) NETWORK CO., LTD., Hangzhou, Zhejiang (CN)

(72) Inventors: Jiajun FAN, Hangzhou, Zhejiang (CN); Xiyu WANG, Hangzhou, Zhejiang (CN); Bincheng XU, Hangzhou, Zhejiang (CN)

(73) Assignee: NETEASE (HANGZHOU) NETWORK CO., LTD., Hangzhou, Zhejiang (CN)

(21) Appl. No.: 18/992,203

(22) PCT Filed: Apr. 17, 2023
(86) PCT No.: PCT/CN2023/088746

§ 371 Date: Jan. 8, 2025

(30) Foreign Application Priority Data
Jul. 8, 2022 (CN) 202210800879.2

(51) Int. Cl. A63F 13/55; A63F 13/2145; A63F 13/426; A63F 13/5372

(52) U.S. Cl. CPC A63F 13/55; A63F 13/2145; A63F 13/426; A63F 13/5372; A63F 2300/1075

(57) ABSTRACT

A virtual object switching method includes: determining an initial lock virtual object from a plurality of virtual objects; in response to a drag operation on a first touch area in the graphical user interface, according to an operation parameter of the drag operation, determining a first switching object from the multiple virtual objects according to a first switching order with the initial lock virtual object as a starting point; and in response to a release operation on the first touch area, determining the first switching object to be a target object.

### CROSS REFERENCE TO RELATED APPLICATION(S)

The present disclosure is a U.S. National Stage of International Application No. PCT/CN2023/088746, filed on Apr. 17, 2023, which claims priority to Chinese patent application No. 202210800879.2, filed on Jul. 8, 2022 and entitled “VIRTUAL OBJECT SWITCHING METHOD AND APPARATUS, STORAGE MEDIUM AND ELECTRONIC APPARATUS”, the entire content of both of which is incorporated herein by reference for all purposes.

### TECHNICAL FIELD

The present disclosure relates to the computer technical field, and in particular to a virtual object switching method and apparatus, a storage medium and an electronic apparatus.

### BACKGROUND

At present, with the rise of popularity of action games, the action games are widely used in various game terminals, such as computers, mobile phones, tablets, etc. For a mobile game, a player usually input commands into a game terminal with his/her finger(s). For example, the player uses his/her finger(s) to control the movement and attack skills of a virtual character. However, since the control of the virtual character keeps the player's finger(s) occupied, it will become more difficult for the player to switch the objects to be attacked.

In addition, when the number of objects to be attacked is small or the target positions of the objects to be attacked are scattered, the player can quickly and accurately switch the objects to be attacked. However, when the number of objects to be attacked is too large or the positions of the objects to be attacked are dense, the player may not be able to accurately identify the object(s) to be attacked or cannot accurately select the object(s) to be attacked.

In related art, a player may lock an object to be attacked by one-click/one-tap of a lock control. When the player clicks/taps the control again, an object in the game scene is randomly selected, and long pressing the control cancels the selection of object. However, since the switching of objects in this scheme is random and the switching rule is not determined by the player, the player cannot autonomously select an object to be attacked, nor can the player foresee the object to be switched to and the information of the object. Moreover, since the object to be attacked may not be in the current shot, this solution also involves shot cut. When the player is playing the game, the game shot may suddenly change. For example, in a game interface shown in FIG. 1, there are two enemy objects. When a player performs switching of the objects, the game suddenly switches to the game interface shown in FIG. 2, and the player's gaming experience is poor.

### SUMMARY

According to an embodiment of the present disclosure, a virtual object switching method is provided. The method includes: determining an initial lock virtual object from a plurality of virtual objects in a game scene comprised in a graphical user interface provided by a terminal device; in response to a drag operation on a first touch area in the graphical user interface, according to an operation parameter of the drag operation, determining a first switching object from the plurality of virtual objects according to a first switching order with the initial lock virtual object as a starting point; and in response to a release operation on the first touch area, determining the first switching object to be a target object.

According to an embodiment of the present disclosure, a non-transitory computer-readable storage medium is further provided. A computer program is stored in the computer-readable storage medium. The computer program is configured to implement the above-mentioned virtual object switching method when the computer program is executed by a processor.

According to an embodiment of the present disclosure, an electronic apparatus is provided. The electronic apparatus includes a memory and a processor. A computer program is stored in the memory, and the processor is configured to run the computer program to implement the above-mentioned virtual object switching method.

It can be seen that the solutions provided by the present disclosure achieves the purpose of switching a plurality of virtual objects, thereby realizing the technical effect of a player autonomously selecting a virtual object, and thus solving the technical problem in the related art that a player cannot autonomously select a virtual object in a game.

### BRIEF DESCRIPTION OF THE DRAWINGS

The drawings described herein are used to provide a further understanding of the present disclosure and constitute a part of the present disclosure. The illustrative embodiments of the present disclosure and their descriptions are used to explain the present disclosure and do not constitute an improper limitation on the present disclosure. In the drawings:

FIG. 1 is a schematic diagram of a game interface in related art;

FIG. 2 is a schematic diagram of a game interface in related art;

FIG. 3 is a block diagram showing a hardware structure of a mobile terminal for performing a virtual object switching method according to an embodiment of the present disclosure;

FIG. 4 is a flowchart of a virtual object switching method according to an embodiment of the present disclosure;

FIG. 5 is a schematic diagram of a graphical user interface according to an embodiment of the present disclosure;

FIG. 6 is a schematic diagram of a graphical user interface according to an embodiment of the present disclosure;

FIG. 7 is a schematic diagram of a graphical user interface according to an embodiment of the present disclosure;

FIG. 8 is a schematic diagram of a graphical user interface according to an embodiment of the present disclosure;

FIG. 9 is a schematic diagram of determining a drag distance according to an embodiment of the present disclosure;

FIG. 10 is a schematic diagram of switching perception according to an embodiment of the present disclosure;

FIG. 11 is a schematic diagram of determining a first switching order according to an embodiment of the present disclosure;

FIG. 12 is a schematic diagram of mapping positions according to an embodiment of the present disclosure;

FIG. 13 is a schematic diagram of mapping positions according to an embodiment of the present disclosure;

FIG. 14 is a schematic diagram of a graphical user interface according to an embodiment of the present disclosure;

FIG. 15 is a schematic diagram of a graphical user interface according to an embodiment of the present disclosure;

FIG. 16 is a schematic diagram of a graphical user interface according to an embodiment of the present disclosure;

FIG. 17 is a schematic diagram of a graphical user interface according to an embodiment of the present disclosure;

FIG. 18 is a schematic diagram of a graphical user interface according to an embodiment of the present disclosure;

FIG. 19 is a schematic diagram of an interface for switching an entire object according to an embodiment of the present disclosure;

FIG. 20 is a structural block diagram of a virtual object switching apparatus according to an embodiment of the present disclosure;

FIG. 21 is a schematic diagram of an electronic apparatus according to an embodiment of the present disclosure.

### DETAILED DESCRIPTION

In order to enable those skilled in the art to better understand the solutions of the present disclosure, the technical solutions in the embodiments of the present disclosure will be clearly and completely described below in conjunction with the drawings in the embodiments of the present disclosure. Obviously, the described embodiments are only a part of the embodiments of the present disclosure, not all of the embodiments. Based on the embodiments in the present disclosure, all other embodiments obtained by those of ordinary skill in this art without creative work should fall within the scope of protection of the present disclosure.

It should be noted that the terms “first”, “second”, etc. in the specification and claims of the present disclosure and the above-mentioned drawings are used to distinguish similar objects, and are not necessarily used to describe a specific order or sequence. It should be understood that the data used in this way can be interchangeable where appropriate, so that the embodiments of the present disclosure described herein can be implemented in an order other than those illustrated or described herein. In addition, the terms “including/comprising” and “having” and any variations thereof are intended to cover non-exclusive inclusion. For example, a process, method, system, product, or device that includes a series of steps or units is not necessarily limited to those steps or units that are clearly listed, but may include other steps or units that are not clearly listed or inherent to the process, method, product, or device.

According to an embodiment of the present disclosure, an embodiment of a virtual object switching method is provided. It should be noted that steps shown in the flowcharts of the accompanying drawings may be executed in a computer system including for example a set of computer executable instructions, and although logical orders are shown in the flowcharts, the steps shown or described may be executed in an order different from that shown here in some cases.

In an embodiment of the present disclosure, the virtual object switching method may be run on a local terminal device or a server. When the virtual object switching method is run on the server, the virtual object switching method may be implemented and executed based on a cloud interaction system. The cloud interaction system includes a server and a client device.

In some implementations, various cloud applications may be run under the cloud interaction system, such as cloud games. Taking a cloud game as an example, a cloud game refers to a game mode based on cloud computing. In the running mode of the cloud game, a body for running a game program and a body for presenting game graphics are separated. The storage and running of the virtual object switching method are completed on the cloud game server. The role of the client device is used for receiving and sending data and presenting the game graphics. For example, the client device may be a display device with a data transmission function close to the user side, such as a mobile terminal, a TV, a computer, a handheld computer, etc.; but it is the cloud game server in the cloud that is used for virtual object switching. When playing the game, a player operates the client device to send an operation instruction to the cloud game server. The cloud game server runs the game according to the operation instruction, encodes and compresses data such as game graphics, and returns the data to the client device through the network. Finally, the client device performs decoding and outputs the game graphics.

In some embodiments, taking a game as an example, a local terminal device stores a game program and is used to present game graphics. The local terminal device is used to interact with a player through a graphical user interface, that is, the game program is downloaded and installed and run by an electronic apparatus in a conventional manner. The local terminal device may provide a graphical user interface to the player in a variety of ways. For example, the graphical user interface may be rendered and displayed on a display screen of the terminal, or the graphical user interface may be provided to the player through a holographic projection. For example, the local terminal device may include a display screen and a processor. The display screen is configured to present a graphical user interface, and the graphical user interface includes game graphics. The processor is configured to run the game, generate the graphical user interface, and control the graphical user interface to be displayed on the display screen.

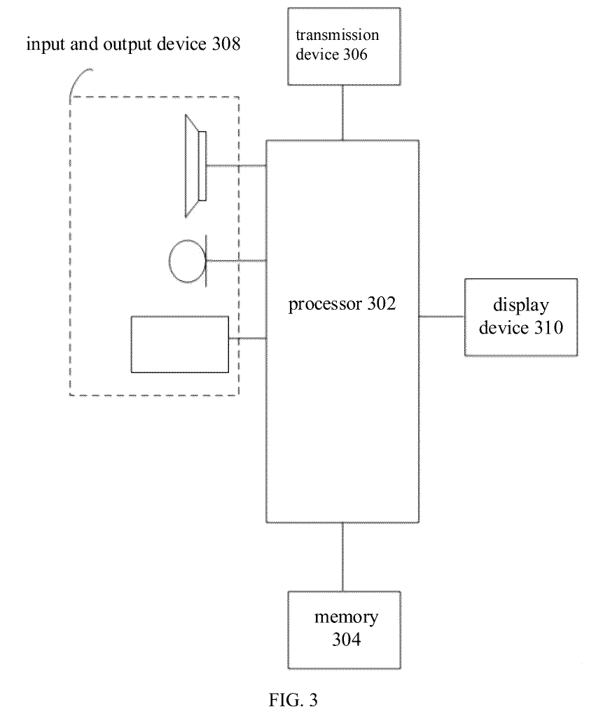

The local terminal device may be a mobile terminal, a computer terminal or a similar computing device. Taking a mobile terminal as an example, the mobile terminal may be a terminal device such as a smart phone (for example, an Android phone, an iOS phone, etc.), a tablet computer, a handheld computer, and a mobile Internet device (referred to as MID), a PAD, or a game console, and so on. FIG. 3 is a block diagram of a hardware structure of a mobile terminal for performing a virtual object switching method in an embodiment of the present disclosure. As shown in FIG. 3, the mobile terminal may include one or more processors 302 (only one processor is shown in FIG. 3) and a memory 304 for storing data, and the processor(s) 302 may include, but not limited to, a processing apparatus such as a Central Processing Unit (CPU), a Graphics Processing Unit (GPU), a Digital Signal Processing (DSP) chip, a microprocessor (MCU), a programmable logic device (FPGA), a Neural-network Processing Unit (NPU), a Tensor Processing Unit (TPU), an artificial intelligence (AI) type processor, etc. In some examples, the mobile terminal may further include a transmission device 306 for communication functions, an input and output device 308 and a display device 310. It can be understood by those skilled in the art that the structure shown in FIG. 3 is only for illustration and does not limit the structure of the mobile terminal. For example, the mobile terminal may include more or fewer components than those shown in FIG. 3, or have a configuration different from that shown in FIG. 3.

The memory 304 may be used to store computer programs, for example, software programs and modules of application software, such as a computer program corresponding to the virtual object switching method in the embodiments of the present disclosure. The processor(s) 302 executes (execute) various functional applications and data processing by running the computer program(s) stored in the memory 304, that is, to implement the virtual object switching method described above. The memory 304 may include a high-speed random access memory, and may further include a non-volatile memory, such as one or more magnetic storage devices, a flash memory, or other non-volatile solid-state memory. In some embodiments, the memory 304 may further include memory (memories) remotely arranged relative to the processor(s) 302, and these remote memories may be connected to the mobile terminal via a network. Examples of the above-mentioned network include, but are not limited to, the Internet, an intranet, a local area network, a mobile communication network, and a combination thereof.

The transmission device 306 is used to receive or send data via a network. A specific example of the above network may include a wireless network provided by a communication provider of the mobile terminal. In an example, the transmission device 306 includes a network adapter (Network Interface Controller, referred to as NIC), which may be connected to other network device(s) through a base station so as to communicate with the Internet. In an example, the transmission device 306 may be a Radio Frequency (RF) module, which is used to communicate with the Internet wirelessly.

The input in the input and output device 308 may come from a plurality of Human Interface Devices (referred to as HIDs), for example, a keyboard and a mouse, a game controller, other dedicated game controllers (such as, a steering wheel, a fishing rod, a dance pad, a remote control, etc.). In addition to providing an input function, some human interface devices can also provide an output function, such as, force feedback and vibration of a game controller, an audio output of a controller, etc.

The display device 310 may be, for example, a head-up display (HUD), a touch-screen liquid crystal display (LCD), and a touch display (also referred to as a “touch screen” or “touch display screen”). The liquid crystal display may enable a user to interact with a user interface of the mobile terminal. In some embodiments, the mobile terminal has a Graphical User Interface (GUI), and a user may perform human-machine interaction(s) with the GUI by a finger contact and/or a gesture on a touch-sensitive surface. In some examples, the human-machine interaction functions here may include the following interactions: creating a web page, drawing, word processing, making an electronic document, gaming, video conferencing, instant messaging, sending and receiving emails, call interfaces, playing digital videos, playing digital music, and/or web browsing, etc. Executable instructions for executing the above-mentioned human-machine interaction functions are configured/stored in a computer program product or a readable storage medium executable by one or more processors.

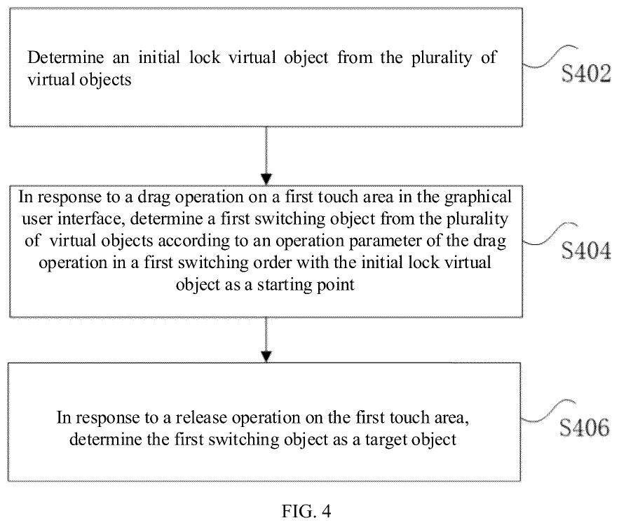

In some implementations, an embodiment of the present disclosure provides a virtual object switching method. A graphical user interface is provided by a terminal device. The terminal device may be the local terminal device mentioned above, or may be a client device in the cloud interaction system mentioned above. FIG. 4 is a flowchart of a virtual object switching method according to an embodiment of the present disclosure, where a graphical user interface is provided by a terminal device, and the content displayed by the graphical user interface includes at least a part of a game scene and a plurality of virtual objects in the game scene. The terminal device may be the local terminal device mentioned above, or may be a client device in the cloud interaction system mentioned above. As shown in FIG. 4, the method includes the following steps:

In step S402, an initial lock virtual object is determined from the plurality of virtual objects.

In step S402, the plurality of virtual objects may be objects in an enemy camp in a game, and the above-mentioned initial lock virtual object is the first virtual object for switching in the procedure of switching the plurality of virtual objects. For example, the initial lock virtual object may be a virtual object located at the middle position of the graphical user interface among the plurality of virtual objects; the initial lock virtual object may also be a virtual object with the lowest health point among the plurality of virtual objects; the initial lock virtual object may also be a virtual object that is closest to the virtual object controlled by the player among the plurality of virtual objects.

It should be noted that, in certain scenarios, the plurality of virtual objects may also be objects in the same camp in a game which a player is playing. For example, in a multiplayer game, the plurality of virtual objects may be objects in the same camp as the virtual object controlled by the player, that is, the plurality of virtual objects are friendly objects to the virtual object controlled by the player. Correspondingly, the initial lock virtual object may be a virtual object located at the middle position of the graphical user interface among the plurality of virtual objects; the initial lock virtual object may also be a virtual object that the player wants to rescue among the plurality of virtual objects; or the initial lock virtual object may also be a virtual object with the lowest health point among the plurality of virtual objects; the initial lock virtual object may also be a virtual object that is closest to the virtual object controlled by the player among the plurality of virtual objects.

In addition, it should be noted that the initial lock virtual object may also be a virtual object that meets other condition(s), examples of which will be not be provided here.

It is easily noted that in step S402, the initial lock virtual object is a virtual object among the plurality of virtual objects displayed by the graphical user interface, that is, the first virtual object to be switched is a virtual object currently displayed by the graphical user interface, and therefore, when switching objects, the player can foresee when the virtual shot will be switched, thereby enabling the player to foresee the switching of virtual objects and switching of the virtual shot, and thus improving the player's gaming experience.

In step S404, in response to a drag operation on a first touch area in the graphical user interface, a first switching object is determined from the plurality of virtual objects according to an operation parameter of the drag operation in a first switching order with the initial lock virtual object as a starting point.

In step S404, the first touch area is an area in the graphical user interface operated by the player to control switching between virtual objects. In this embodiment, the player's drag operation on the first touch area may be a drag operation of a control corresponding to the touch area. That is, in this embodiment, the first touch area may be an area corresponding to a first switching control, where the first switching control is a control operated by the player to control switching between virtual objects.

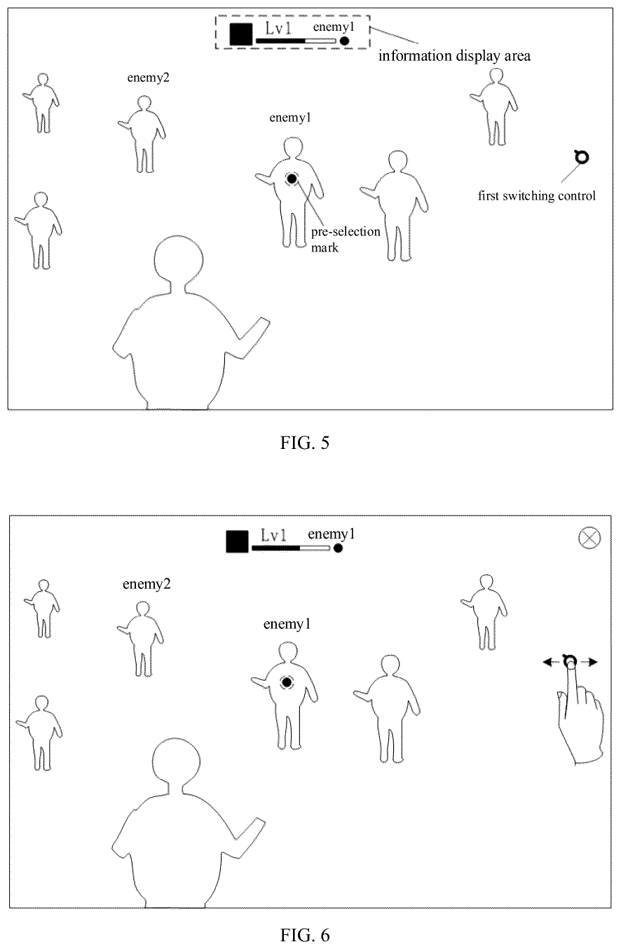

In addition, in step S404, the operation parameter of the player's drag operation on the first touch area may include, but not limited to, any one or more of: a drag distance, a drag speed, a drag direction of the player's dragging of the first touch area. For example, in a graphical user interface shown in FIG. 5, taking the operation parameter being the drag distance as an example, the initial lock virtual object is enemy 1, that is, the first switching object is enemy 1; when the player drags a first switching control to the left, the first switching object is switched from enemy 1 to enemy 2. If the player continues to drag the first switching control to the left, the first switching object is switched from enemy 2 to an virtual object on the left side of enemy 2.

It should be noted that the above-mentioned first switching order may be determined according to positions of the plurality of virtual objects in the graphical user interface. That is, after determining the initial lock virtual object, if the player drags the first switching control to the left, the game terminal takes the initial lock virtual object as the starting point and switches the virtual objects to the left in sequence; if the player drags the first switching control to the right, the game terminal takes the initial lock virtual object as the starting point and switches the virtual objects to the right in sequence.

In addition, it should be noted that in actual applications, the player may also increase the switching speed of the virtual objects by clicking/tapping or flinging the first touch area. For example, each time the player clicks/taps the first touch area, the game terminal switches a virtual object. For another example, in a scenario of flinging the first touch area, the player's touch medium (e.g., finger) touches the screen of the game terminal while sliding, and quickly releases the first touch area, thereby achieving the purpose of quickly switching virtual objects.

Through step S404, the switching of a plurality of virtual objects is performed in a certain switching order. Therefore, before completing the switching of plurality of virtual objects, the player can foresee the next virtual object to be switched to, thereby avoiding the problem in related art that the player cannot foresee the virtual object to be switched to. In addition, in the procedure of switching a plurality of virtual objects, the plurality of virtual objects are switched in a certain switching order, that is, in the procedure of switching a plurality of virtual objects, each virtual object may be switched to, thereby avoiding the problem in the related art that accurate switching cannot be realized due to large number of virtual objects and/or dense positions. Thus, the embodiments of the present disclosure can achieve accurate switching of virtual objects.

In step S406, in response to a release operation on the first touch area, the first switching object is determined as a target object.

In step S406, the player's release operation on the first touch area may be, but not limited to, a hand-raising operation (for example, releasing the player's operation on the input device), a heavy press operation (pressing the first touch area with a pressure greater than a preset pressure), a long press operation (pressing the first touch area for a duration greater than a preset duration). When the player releases the first touch area, the first switching object is the target object selected by the player. For example, when the player releases the first touch area, the first switching object is enemy 2, and enemy 2 is the object to be attacked by the player.

It should be noted that the player determines the target object from the plurality of virtual objects through the drag operation on the first touch area and by releasing the first touch area. It can be seen that the player can autonomously choose to perform switching between the plurality of virtual objects, thereby achieving the purpose of enabling the player to autonomously select a virtual object.

Based on the solution defined by the above steps S402 to S406, it can be known that in this embodiment, the object switching is realized by dragging the switching control. The initial lock virtual object is determined from the plurality of virtual objects displayed in the graphical user interface, and in response to the drag operation on the first touch area in the graphical user interface, according to the operation parameter of the drag operation, the first switching object is determined from the plurality of virtual objects in accordance with the first switching order, with the initial lock virtual object as the starting point. And, in response to the release operation on the first touch area, the first switching object is determined as the target object.

It is easily noted that in the above procedure, the player can determine the target object from the plurality of virtual objects by the dragging operation on the first touch area. It can be seen that in the solution disclosed in the present disclosure, the player can autonomously choose to switch a plurality of virtual objects, thereby achieving the purpose of the player's autonomous selection of virtual objects. In addition, in the present disclosure, the switching of a plurality of virtual objects is performed according to a certain switching order. Therefore, before completing the switching of the plurality of virtual objects, the player can foresee the next virtual object to be switched to, thereby avoiding the problem in relate art that the player cannot foresee the virtual object to be switched to. In addition, in the procedure of switching a plurality of virtual objects, the plurality of virtual objects are switched according to a certain switching order, that is, in the procedure of switching a plurality of virtual objects, each virtual object may be switched to, thereby avoiding the problem in related art that accurate switching cannot be realized due to large number of virtual objects and/or dense positions. Thus, the embodiments of the present disclosure can achieve accurate switching of virtual objects.

It can be seen that the solutions provided by the present disclosure achieves the purpose of switching a plurality of virtual objects, thereby realizing the technical effect of enabling a player to autonomously select virtual objects. Thus, the solutions can solve the technical problem in the related art that a player cannot autonomously select virtual object(s) in a game.

In some embodiments, before switching of the plurality of virtual objects, the game terminal needs to determine the initial lock virtual object from the plurality of virtual objects displayed in the graphical user interface. Specifically, the game terminal determines the initial lock virtual object from the plurality of virtual objects according to the position information of the plurality of virtual objects in the graphical user interface.

In some examples, the player may first send a game control instruction to the game terminal, and the game control instruction indicates that the player needs to perform switching of virtual objects. The game control instruction may be an operation instruction for a certain control (for example, click/tap, long press, drag, etc.), or a voice instruction, a gesture instruction, an expression instruction, etc. After receiving the game control instruction, the game terminal may take a virtual object at the middle position of the graphical user interface as the initial lock virtual object, and perform a lock operation on the initial lock virtual object at the same time. That is, when the initial lock virtual object moves and/or the player's touch medium (for example, finger) drags the screen to change the viewing angle, the locked initial lock virtual object is always at the middle position of the graphical user interface, and adapts to the shot change according to a certain rule.

It should be noted that by performing a lock operation on the initial lock virtual object, when switching the shot, the problem of poor gaming experience for the player caused by sudden shot switching in the related art can be avoided. Moreover, when switching object(s), the player can foresee when the virtual shot will switch, so that the player can foresee the switching of the virtual object(s) and the switching of the virtual shot, which improves the player's gaming experience.

Furthermore, after determining the initial lock virtual object from the plurality of virtual objects, the game terminal can, in response to a drag operation on the first touch area in the graphical user interface, determine the first switching object from the plurality of virtual objects according to the operation parameter of the drag operation in a first switching order with the initial lock virtual object as the starting point.

Specifically, in response to a first operation on the first touch area, the game terminal records a first operation duration of the first operation, and when the first operation duration is greater than a first preset duration, the game terminal displays a pre-selection mark in an object area corresponding to the initial lock virtual object. Then, according to the first switching order, with the initial lock virtual object as the starting point, the game terminal switches the plurality of virtual objects in sequence, and determines, from the plurality of virtual objects, the first switching object corresponding to the first drag distance of the drag operation, and displays the pre-selection mark in an object area corresponding to the first switching object.

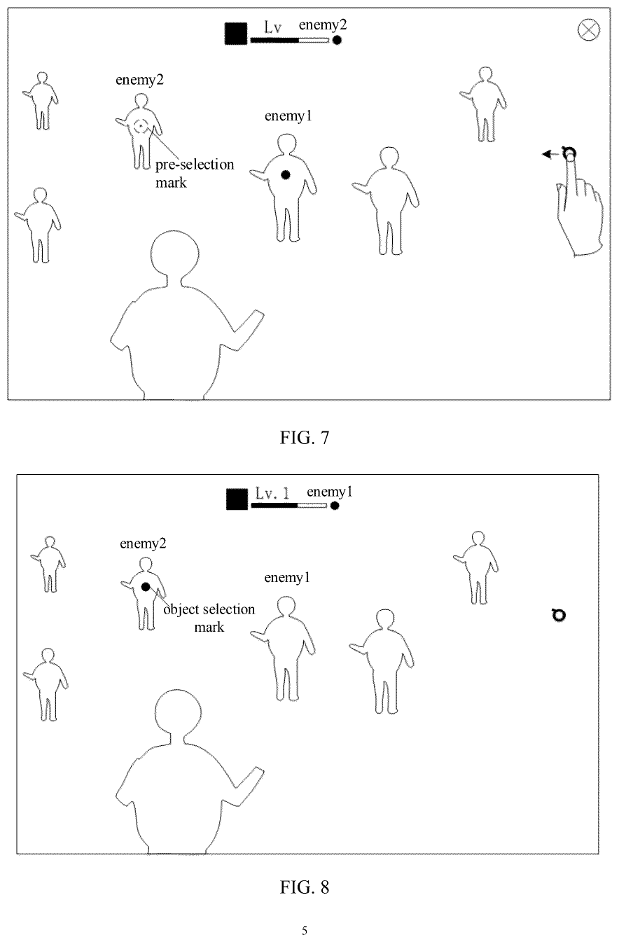

In some examples, the pre-selection mark indicates that a virtual object with the pre-selection mark is the object currently switched to. For example, in the graphical user interface shown in FIG. 5, the pre-selection mark is set on enemy 1, indicating that the virtual object currently switched to is enemy 1. At this time, the player can drag the first switching control left and right, as shown in FIG. 6, so as to switch between a plurality of virtual objects. If the player drags the first switching control to the left, as shown in FIG. 7, the pre-selection mark moves from enemy 1 to enemy 2, indicating that the virtual object currently switched to is enemy 2. After the player releases the first switching control, as shown in FIG. 8, an object selection mark is displayed in an object area corresponding to enemy 2, and the object selection mark indicates that the player has selected enemy 2.

In addition, the first operation mentioned above may be a long press operation. That is, the player long presses the first touch area, and the game terminal enters a game scene for switching virtual objects. In this game scene, the player can drag the first touch area to perform switching between virtual objects.

It should be noted that by long pressing the first touch area, the game terminal can be notified to enter the game scene of switching virtual objects, without setting other touch area or operating other control. This can avoid the problem of affecting the player's game field of view due to addition of other control which may occupy the graphical user interface and can also avoid the problem of cumbersome operations caused by the player operating other controls.

Further, after determining the initial lock virtual object from the plurality of virtual objects, the game terminal can, in response to the player's drag operation on the first touch area, perform switching between the plurality of virtual objects. The game terminal performs switching between the plurality of virtual objects according to the first drag distance of the player on the first touch area. In the procedure of determining the first drag distance, the game terminal may determine the first drag distance based on a central axis of the first touch area, or the game terminal may determine the first drag distance according to a touch position of the player on the screen.

In some examples, in a scenario where the first drag distance is determined based on the central axis of the first touch area, the game terminal determines the position of the central axis of the first touch area to obtain a first position, and determines the current position after the touch medium drags the first touch area to obtain a second position, and then determines the first drag distance based on a distance between the first position and the second position.

It should be noted that the above-mentioned touch medium may be but is not limited to the player's finger. That is, the current position of the first touch area is the position (i.e., the second position) of the first touch area after the player drags the first touch area, and the second position can also be determined based on the central axis of the first touch area. That is, in this scenario, the first drag distance of the first touch area is the distance between the central axis of the first touch area before dragging and the central axis of the first touch area after dragging.

In some examples, in a scenario where the first drag distance is determined by the player's touch position on the screen, the game terminal determines an initial position of the touch medium when the touch medium drags the first touch area on the graphical user interface to obtain a first position, and determines the current position after the touch medium drags the first touch area to obtain a second position, and then determines the first drag distance based on a distance between the first position and the second position.

It should be noted that, in actual applications, the position where the player touches the first touch area is not necessarily the position of the central axis of the first touch area. Therefore, in this embodiment, the game terminal can also determine the first drag distance based on the touch start position and the current touch position of the touch medium of the player.

In some embodiments, after determining the method for calculating the first drag distance, the game terminal can perform switching between a plurality of virtual objects in sequence according to the first switching order with the initial lock virtual object as the starting point, and determine, from the plurality of virtual objects, the first switching object corresponding to the first drag distance of the drag operation. Specifically, the game terminal displays a pre-selection mark in the object area corresponding to the initial lock virtual object, and when the first drag distance is greater than the first distance threshold, displays the pre-selection mark in an object area corresponding to the next object, where the next object is the next switching object corresponding to the first switching object in the first switching order.

It should be noted that the above-mentioned object area may be an area of a virtual object in the game scene. For example, as shown in FIG. 7, an object area is an area formed by the entire human body corresponding to a virtual object. The above-mentioned first distance threshold may be but is not limited to 60 px. For example, in the schematic diagram of determining the drag distance shown in FIG. 9, the first touch area is the first switching control, and the player achieves switching between virtual objects by dragging the first switching control left and right. That is, the player may drag the first switching control to the left or right from the central axis of the first switching control. The game terminal performs switching of the virtual objects according to the movement distance of the central axis of the first switching control. That is, the game terminal performs switching of the virtual object once every time the player drags by 60 px. For example, as shown in FIG. 7, if the player drags by 60 px, the object currently switched to is switched from enemy 1 to enemy 2, and the pre-selection mark is displayed in the object area of enemy 2.

Furthermore, in order to enable the player to perceive the trend of the switching between the virtual objects and improve the player's gaming experience during the switching between the virtual objects, in an embodiment, the game terminal also determines a drag direction corresponding to the drag operation, and determines the movement distance corresponding to the pre-selection mark according to the first drag distance, and then controls the pre-selection mark to stop moving when the movement distance is greater than the second distance threshold. The second distance threshold is smaller than the first distance threshold, and the movement distance is the distance that the pre-selection mark moves in the object area corresponding to the current lock virtual object according to the drag direction.

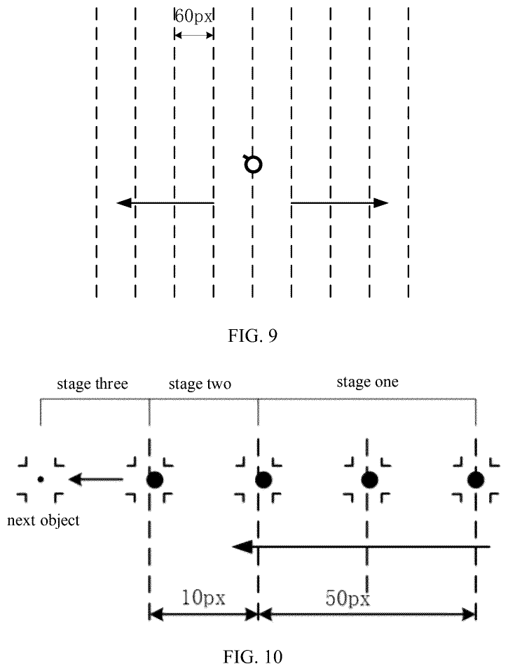

In some examples, the switching perception schematic diagram shown in FIG. 10 is used as an example for explanation. The first touch area is the first switching control. As shown in FIG. 10, the procedure includes three stages. In addition, the above-mentioned first distance threshold is 60 px, and the second distance threshold is 10 px. That is, as the distance the player drags the first switching control increases, the pre-selection mark will shift slightly. As shown in FIG. 10, in stage one, the player drags the first switching control to the left by 50 px, and the pre-selection mark shifts to the left by 10 px. In stage two, the player continues to drag the first switching control to the left, and the pre-selection mark no longer shifts. In stage three, if the player continues to drag the first switching control to the left, at this time, the drag distance of the first switching control is greater than 60 px, then the pre-selection mark moves from the first switching object to the next object.

It should be noted that, in the procedure of performing switching between a plurality of virtual objects, the game terminal also needs to determine the switching order of the virtual objects. The game terminal may determine the switching order by mapping the positions of the virtual objects onto a specific direction.

Specifically, after responding to the drag operation on the first touch area, the game terminal maps the position information of a plurality of virtual objects in the graphical user interface onto a preset direction, obtains the mapping positions corresponding to the plurality of virtual objects, and determines the first switching order for switching the plurality of virtual objects according to the mapping positions corresponding to the plurality of virtual objects and an initial mapping position of the initial lock virtual object.

It should be noted that the preset direction may be a horizontal direction, or a vertical direction, or a direction at a preset angle to the horizontal direction. In this embodiment, the preset direction is a horizontal direction as an example for description, where the horizontal direction is the horizontal axis direction of the screen.

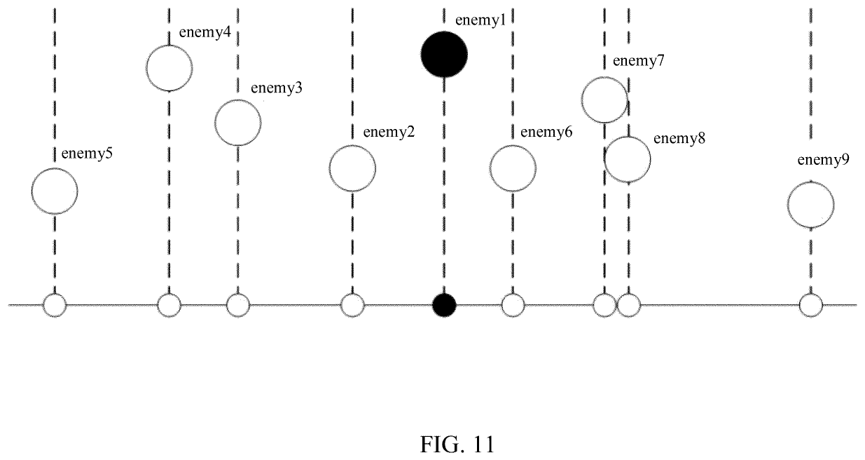

In some examples, as shown in the schematic diagram for determining the first switching order in FIG. 11, the game terminal maps the positions of all virtual objects onto the horizontal direction. With the initial lock virtual object (i.e., enemy 1 in FIG. 11) as the starting point, the first switching order is determined according to the drag direction in which the player drags the first touch area. For example, as shown in FIG. 11, if the player drags the first switching control to the left, the first switching order is: enemy 1-enemy 2-enemy 3-enemy 4-enemy 5. As shown in FIG. 11, if the player drags the first switching control to the right, the first switching order is: enemy 1-enemy 6-enemy 7-enemy 8-enemy 9.

It should be noted that, in actual applications, if the leftmost or rightmost virtual object has been switched to, and the player continues to drag the switching control, the game terminal can perform switching cyclically from the other end. For example, in FIG. 11, if the player drags the first switching control to the left, the switching of virtual objects is performed in the order of enemy 1-enemy 2-enemy 3-enemy 4-enemy 5. If the object currently switched to is enemy 5 and the player continues to drag the first switching control to the left, the game terminal switches from enemy 5 to enemy 9, and switches between virtual objects cyclically in the order of enemy 9-enemy 8-enemy 7-enemy 6-enemy 1-enemy 2-enemy 3-enemy 4 enemy 5-enemy 9.

In addition, if the virtual object has been switched to the leftmost or rightmost and the player continues to drag the switching control, the game terminal may not perform cyclic switching. For example, as shown in FIG. 11, if the player drags the first switching control to the left, switching between virtual objects is performed in the order of enemy 1-enemy 2-enemy 3-enemy 4-enemy 5. If the current switching object is enemy 5 and the player continues to drag the first switching control to the left, the game terminal no longer performs switching of the virtual objects and directly generates prompt information to remind the player that the switching of virtual objects has been completed and that the player needs to perform the operation again if he wants to continue switching.

In addition, in the procedure of mapping virtual objects onto the preset direction, there may be a scenario where at least two virtual objects have the same mapping position. In this scenario, the game terminal needs to use other method(s) to determine the switching order of these virtual objects with overlapping mapping positions.

Specifically, when it is detected that the mapping positions of at least two virtual objects are the same, the game terminal determines object distances between the at least two virtual objects and a target virtual object, and determines the switching order of the at least two virtual objects according to the object distances.

In the above process, the target virtual object may be the initial lock virtual object or the virtual object controlled by the player. That is, when there are at least two virtual objects with the same mapping positions, the game terminal determines the switching order according to the object distances between the at least two virtual objects and the target virtual object. For example, if the mapping positions of enemies A and B are the same, the game terminal calculates the object distances between enemies A and B and the target virtual object, respectively. If the object distance corresponding to enemy A is smaller than the object distance corresponding to enemy B, enemy A occurs earlier than enemy B in the switching order.

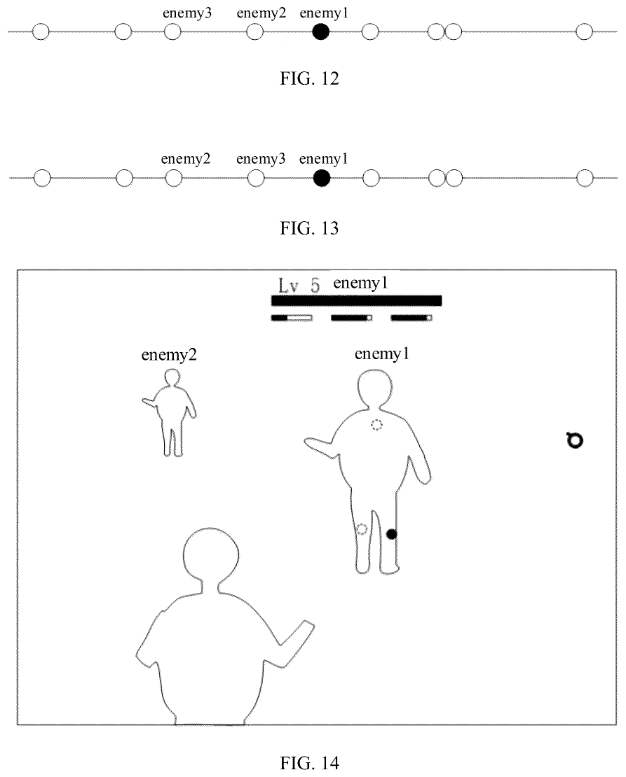

It should be noted that in actual applications, when the player switches virtual objects, the positions of the virtual objects in the graphical user interface are not fixed and may change in real time. When the position of a virtual object in the graphical user interface changes, its corresponding mapping position may also change. For example, in the schematic diagram of the mapping position shown in FIG. 12, enemy 2 is on the right side of enemy 3. However, since the position of enemy 2 or enemy 3 in the game scene has changed, the mapping positions of enemy 2 and enemy 3 also change. For example, in the schematic diagram of the mapping position shown in FIG. 13, enemy 2 is on the left side of enemy 3.

In this scenario, when a change in the position of a first virtual object in the graphical user interface is detected, the game terminal updates the mapping position of the first virtual object in the preset direction, and updates the first switching order based on the mapping position of the first virtual object, where the first virtual object is any one of the plurality of virtual objects. That is, in the above example, after detecting that the mapping position of the virtual object has changed, the game terminal updates the first switching order based on the changed mapping position, thereby ensuring the accuracy of the first switching order.

In some embodiments, as shown in FIG. 5, the content displayed by the graphical user interface further includes an information display area, where the object information of the first switching object is displayed in the information display area. In some examples, the object information may include but is not limited to the avatar, level, identity (for example, name or nickname), health point, or the like of the virtual object.

It should be noted that, in actual applications, some virtual objects have a plurality of selectable positions (i.e., areas to be switched), such as arm, leg, head, etc. For example, in the graphical user interface shown in FIG. 14, the virtual object enemy 1 includes three areas to be switched, where the black dot represents the initial switching area (i.e., the first switching area), and the dotted circle represents the area that is not currently selected. Therefore, for a virtual object that includes a plurality of areas to be switched, the player also selects the area to be switched of the virtual object. For example, the player can select the specific part of the virtual object to be attacked.

Specifically, after determining that the first switching object is the target object in response to the release operation on the first touch area, the game terminal detects whether the target object has a plurality of areas to be switched. When the target object has a plurality of areas to be switched, a preset mark is displayed in a second touch area in the graphical user interface, and in response to a second operation on the first switching control, when a operation duration of the second operation is greater than a second preset duration, corresponding area marks are displayed in the plurality of areas to be switched, and area information of the plurality of areas to be switched is displayed in the information display area, where the preset mark indicates that the first switching object has a plurality of areas to be switched.

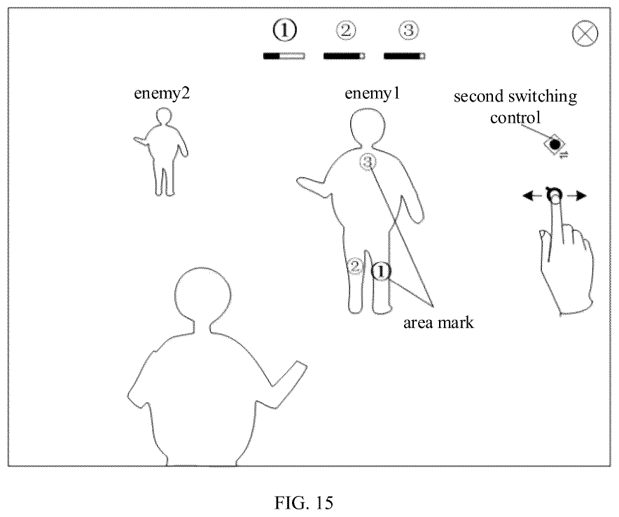

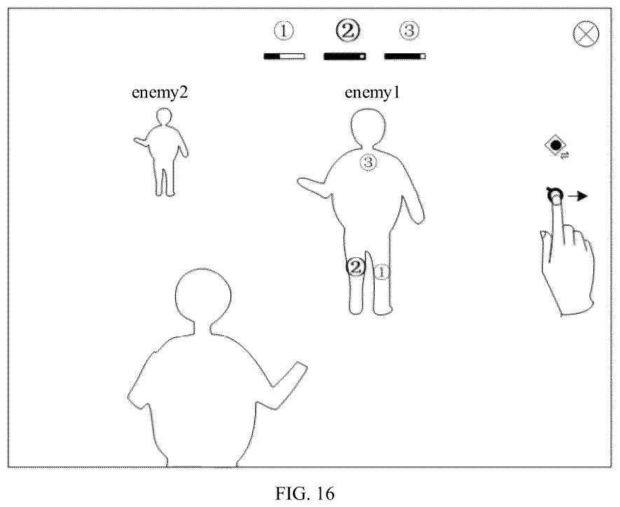

For example, in the graphical user interface shown in FIG. 14, the player selects enemy 1, that is, the player determines that enemy 1 is the virtual object to be attacked. As shown in the figure, enemy 1 has a plurality of areas to be switched, and thus a preset mark is displayed in the graphical user interface shown in FIG. 15. The preset mark may be a mark corresponding to the second touch area, and when the second touch area is the area corresponding to the control, the preset mark may be a mark or an icon corresponding to the second switching control (i.e., the control corresponding to the second touch area). That is, in this embodiment, when there is a preset mark in the graphical user interface, it represents that the current virtual object is a virtual object with a plurality of areas to be switched. Further, in FIG. 15, the first touch area is the area where the first control is located, and the player long presses the first switching control, and the game terminal displays the corresponding area marks in the areas to be switched corresponding to enemy 1, and displays the area information of each area to be switched in the information display area. For example, in FIG. 15, it is displayed that the currently selected area to be switched is area \textcircled{1}, and area \textcircled{1} is highlighted in the information display area. In addition, the information display area not only displays the area marks of the virtual object, but also displays the information corresponding to each area mark, such as the probability of the area being successfully attacked, or the health point of the area. That is, in this embodiment, the area mark corresponding to the area to be switched matches the area mark displayed in the information display area. For example, in FIG. 15, the current area is area \textcircled{1}, and area \textcircled{1} is highlighted in the information display area. For another example, in FIG. 16, the current area is area \textcircled{2}, and area \textcircled{2} is highlighted in the information display area.

It should be noted that, in this embodiment, when the target object has a plurality of areas to be switched, the player can only determine one target area from the plurality of areas to be switched, and the target area may be the area to be attacked.

In some embodiments, the player can also perform switching and selection of a plurality of areas to be switched. Specifically, in response to the drag operation on the first touch area, the game terminal performs switching between the plurality of areas to be switched in sequence according to a second switching order, determines the current switching area corresponding to a second drag distance, and in response to a release operation on the first touch area, determines that the current switching area is a target area corresponding to the target object. The second drag distance is the current drag distance of the drag operation on the first touch area.

In some examples, in the graphical user interface shown in FIG. 16, the first touch area is the area corresponding to the first switching control, and the player can implement the switching operation of a plurality of areas to be switched of the target object by dragging the first switching control left and right. The switching procedure is similar to the switching procedure of the virtual object described above, except that, in the procedure of switching a plurality of areas to be switched, the game terminal determines the switching order according to the area marks corresponding to the plurality of areas to be switched.

In addition, in the procedure of switching a plurality of areas to be switched, the game terminal may also perform cyclic switching of the areas, or not perform the cyclic switching, and the corresponding method is similar to the above-mentioned switching procedure of virtual objects, which will not be repeated here.

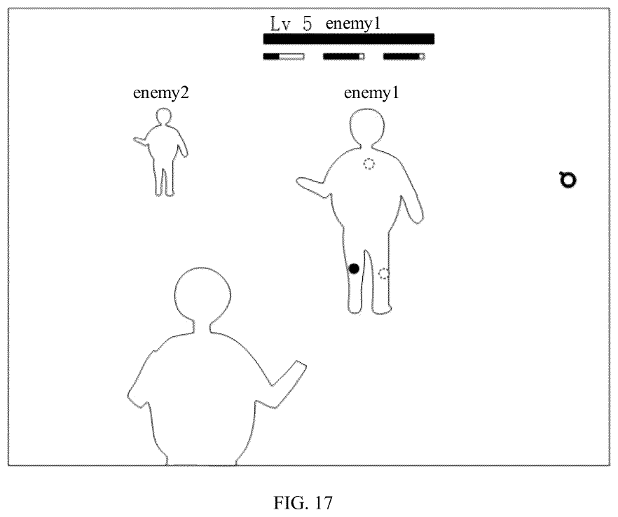

In addition, it should be noted that during the area switching procedure, if the player releases the first touch area, the game terminal uses the current switching area as the target area. For example, in the graphical user interface shown in FIG. 17, the player selects area 2 as the target area. When the player releases the first switching control, the object selection mark is displayed at the position of area \textcircled{2}.

In addition, when the player needs to exit from the selection of the area to be switched and continue to perform switching between the virtual objects, the player may drag the first touch area to the second touch area to realize switching between area selection and whole object selection.

Specifically, when the target object has a plurality of areas to be switched, in response to a drag operation on the first touch area in a first direction, the first touch area is dragged to the position of the second touch area, so that the first touch area and the second touch area at least partially overlap. Then, in response to a drag operation on the first touch area in a second direction, switching of the plurality of virtual objects is performed in sequence according to a first switching order, wherein the first direction is different from the second direction.

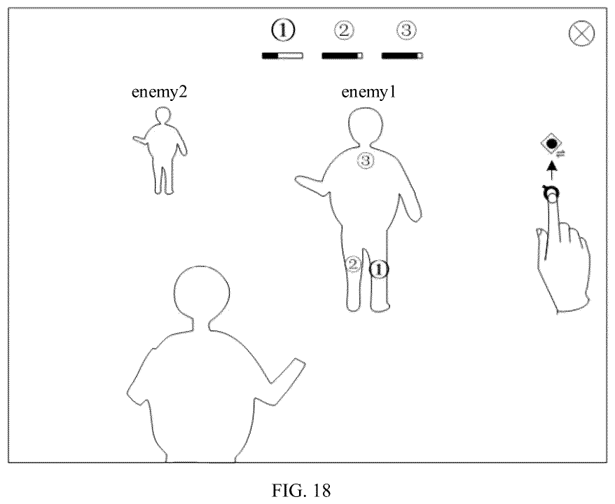

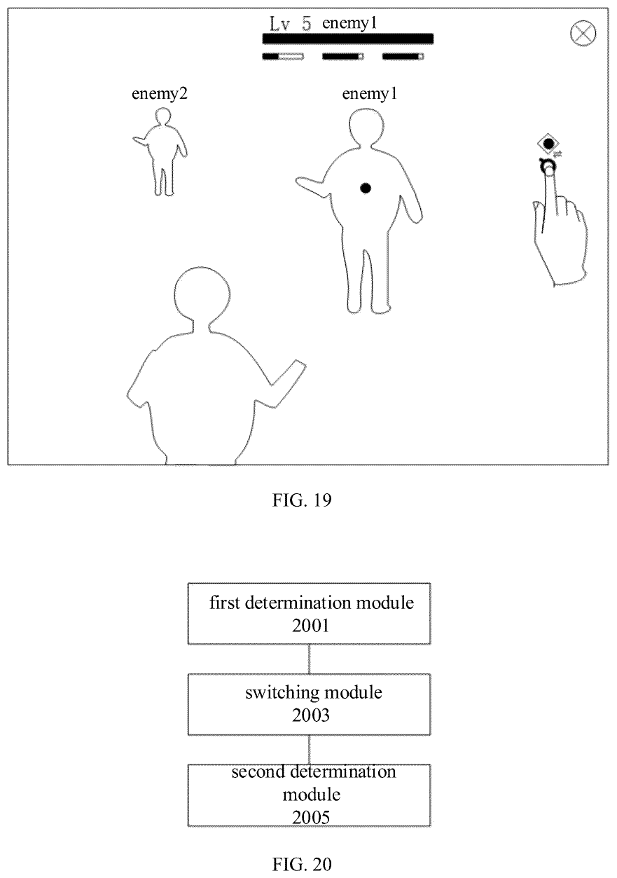

For example, in the graphical user interface shown in FIG. 18, the player needs to switch from area selection to the selection of the entire object. At this time, the player drags the first switch control to the second switch control in the first direction shown in FIG. 18, and the entire object switching interface shown in FIG. 19 is obtained. In FIG. 19, the object selection mark is displayed in the virtual object currently selected by the player. At this time, the player can drag the first switch control left and right to perform switching between virtual objects.

As can be seen from the above content, the solutions provided by the present disclosure achieve accurate selection of virtual objects and areas to be switched by dragging a control. That is, in the present disclosure, a player has the autonomy to switch virtual objects or areas, rather than relying on randomness of the system. Thus, the solutions in the present disclosure can achieve the purpose of enabling player's autonomous selection of virtual object(s). Moreover, in the present disclosure, the graphical user interface has an information display area, through which the player can know the currently selected virtual object or area, thereby enabling the player to better interact with the system. In addition, in the present disclosure, for a virtual object with subareas, it can be ensured that the player will not mistakenly operate on other overall virtual object(s) when performing switching between subareas, and a solution for switching from area selection to overall object selection is also provided, and switching between area selection and overall object selection can be performed freely without affecting each other.

Through the description of the above implementations, those skilled in the art can clearly understand that the methods according to the above embodiments can be implemented by means of software plus a necessary general hardware platform, and of course can also be implemented by hardware, but in many cases the former is a better implementation. Based on such an understanding, the technical solutions of the present disclosure, or the part that contributes to related art, can be embodied in the form of a software product. The software product is stored in a storage medium (such as ROM/RAM, a magnetic disk, or an optical disk), and includes a number of instructions for enabling a terminal device (which can be a mobile phone, a computer, a server, or a network device, etc.) to implement the methods described in the embodiments of the present disclosure.

In some embodiments, a virtual object switching apparatus is also provided. The apparatus is used to implement the above-mentioned embodiments and example implementations, and the descriptions that have been made will not be repeated. As used below, the term “module” can implement a combination of software and/or hardware for a predetermined function. Although the apparatuses described in the following embodiments are preferably implemented in software, the implementation of hardware or a combination of software and hardware is also possible and conceivable.

FIG. 20 is a structural block diagram of a virtual object switching apparatus according to an embodiment of the present disclosure. A graphical user interface is provided by a terminal device, and the content displayed by the graphical user interface includes at least a part of a game scene and a plurality of virtual objects in the game scene. As shown in FIG. 20, the apparatus includes: a first determination module 2001, a switching module 2003 and a second determination module 2005.

The first determination module 2001 is configured to determine an initial lock virtual object from the plurality of virtual objects. The switching module 2003 is configured to, in response to a drag operation on a first touch area in the graphical user interface, according to an operation parameter of the drag operation, determine a first switching object from the plurality of virtual objects according to a first switching order with the initial lock virtual object as a starting point. The second determination module 2005 is configured to, in response to a release operation on the first touch area, determine the first switching object as a target object.

It should be noted here that the first determination module 2001, the switching module 2003 and the second determination module 2005 correspond to steps S402 to S406 of the above-described embodiments, and the three modules and the corresponding steps implement the same instances and application scenarios, but are not limited to the content disclosed in the above-described embodiments.

In some examples, the first determination module includes a third determination module configured to determine the initial lock virtual object from the plurality of virtual objects according to position information of the plurality of virtual objects in the graphical user interface.

In some examples, the switching module includes: a first response module, a first display module and a first switching module. The first response module is configured to, in response to a first operation on the first touch area, record a first operation duration of the first operation. The first display module is configured to display a pre-selection mark in an object area corresponding to the initial lock virtual object when the first operation duration is greater than the first preset duration, where the pre-selection mark indicates that a virtual object with the pre-selection mark is the object currently switched to. The first switching module is configured to switch the plurality of virtual objects in sequence according to the first switching order with the initial lock virtual object as the starting point, determine, from the plurality of virtual objects, the first switching object corresponding to the first drag distance of the drag operation, and display the pre-selection mark in an object area corresponding to the first switching object.

In some examples, the virtual object switching apparatus further includes: a fourth determination module, a fifth determination module and a sixth determination module. The fourth determination module is configured to determine a position of a central axis of the first touch area to obtain a first position. The fifth determination module is configured to determine a current position after a touch medium drags the first touch area to obtain a second position. The sixth determination module is configured to determine the first drag distance according to a distance between the first position and the second position.

In some examples, the virtual object switching apparatus further includes: a seventh determination module, an eighth determination module and a ninth determination module. The seventh determination module is configured to determine an initial position when the touch medium drags the first touch area on the graphical user interface to obtain a first position. The eighth determination module is configured to determine a current position after the touch medium drags the first touch area to obtain a second position. The ninth determination module is configured to determine the first drag distance according to a distance between the first position and the second position.

In some examples, the virtual object switching apparatus further includes: a mapping module and a tenth determination module. The mapping module is configured to map the position information of the plurality of virtual objects in the graphical user interface onto a preset direction to obtain mapping positions corresponding to the plurality of virtual objects. The tenth determination module is configured to determine a first switching order for switching the plurality of virtual objects according to the mapping positions corresponding to the plurality of virtual objects and an initial mapping position of the initial lock virtual object.

In some examples, the virtual object switching apparatus further includes: an eleventh determination module and a twelfth determination module. The eleventh determination module is configured to determine object distances between at least two virtual objects and a target virtual object when it is detected that mapping positions of the at least two virtual objects are the same. The twelfth determination module is configured to determine the switching order of the at least two virtual objects according to the object distances.

In some examples, the virtual object switching apparatus further includes an updating module configured to: update a mapping position of a first virtual object in the preset direction when a change in the position of the first virtual object in the graphical user interface is detected, and update the first switching order based on the mapping position of the first virtual object, where the first virtual object is any one of the plurality of virtual objects.

In some examples, the first switching module includes: a second display module and a second switching module. The second display module is configured to display a pre-selection mark in an object area corresponding to the initial lock virtual object. The second switching module is configured to display the pre-selection mark in an object area corresponding to a next object when the first drag distance is greater than the first distance threshold, where the next object is the next switching object corresponding to the first switching object in the first switching order.

In some examples, the virtual object switching apparatus further includes: a thirteenth determination module, a fourteenth determination module and a control module. The thirteenth determination module is configured to determine a drag direction corresponding to the drag operation. The fourteenth determination module is configured to determine a movement distance corresponding to the pre-selection mark according to the first drag distance, where the movement distance is the distance that the pre-selection mark moves in the object area corresponding to the current lock virtual object according to the drag direction. The control module is configured to control the pre-selection mark to stop moving when the movement distance is greater than a second distance threshold, where the second distance threshold is smaller than the first distance threshold.

In some examples, the content displayed by the graphical user interface further includes an information display area, and the virtual object switching apparatus further includes a third display module configured to display object information of the first switching object in the information display area.

In some examples, the virtual object switching apparatus further includes: a detection module, a fourth display module and a fifth display module. The detection module is configured to detect whether the target object has a plurality of areas to be switched. The fourth display module is configured to display a preset mark at a second touch area in the graphical user interface when the target object has a plurality of areas to be switched, and respond to a second operation on the first touch area, where the preset mark indicates that the first switching object has a plurality of areas to be switched. The fifth display module is configured to display corresponding area marks in the plurality of areas to be switched when an operation duration of the second operation is greater than a second preset duration, and display the area information of the plurality of areas to be switched in the information display area.

In some examples, the virtual object switching apparatus further includes: a second response module and a third response module. The second response module is configured to, in response to the drag operation on the first touch area, switch the plurality of areas to be switched in sequence according to a second switching order, and determine the current switching area corresponding to the second drag distance, where the second drag distance is the current drag distance of the drag operation on the first touch area. The third response module is configured to, in response to the release operation on the first touch area, determine that the current switching area is the target area corresponding to the target object.

In some examples, the virtual object switching apparatus further includes: a fourth response module and a fifth response module. The fourth response module is configured to, when the target object has a plurality of areas to be switched, in response to a drag operation on the first touch area in a first direction, drag the first touch area to the position of the second touch area so that the first touch area and the second touch area at least partially overlap. The fifth response module is configured to, in response to a drag operation on the first touch area in a second direction, sequentially switch the plurality of virtual objects according to the first switching order, where the first direction is different from the second direction.

It should be noted that the above modules can be implemented by software or hardware. For the latter, the modules can be implemented in the following ways, but not limited to: the above modules are all located in the same processor; or the above modules are located in different processors in any combination.

An embodiment of the present disclosure further provides a computer-readable storage medium, in which a computer program is stored. The computer program is configured to, when being run by a processor, implement the steps of any of the above method embodiments.

In some embodiments, the computer-readable storage medium may include but is not limited to: a U disk, a Read-Only Memory (ROM), a Random Access Memory (RAM), a mobile hard disk, a magnetic disk or an optical disk, or other medium that can store computer program(s).

In some embodiments, the computer-readable storage medium may be located in any one of computer terminals in a computer terminal group in a computer network, or in any one of mobile terminals in a mobile terminal group.

In some embodiments, the computer-readable storage medium may be configured to store a computer program for performing the following steps: determining an initial lock virtual object from the plurality of virtual objects; in response to a drag operation on a first touch area in the graphical user interface, according to an operation parameter of the drag operation, determining a first switching object from the plurality of virtual objects according to a first switching order with the initial lock virtual object as a starting point; and in response to a release operation on the first touch area, determining the first switching object to be a target object.

In some embodiments, the computer-readable storage medium is further configured to store a program code for performing the following step: determining the initial lock virtual object from the plurality of virtual objects according to position information of the plurality of virtual objects in the graphical user interface.

In some embodiments, the computer-readable storage medium is further configured to store a program code for performing the following steps: in response to a first operation on a first touch area, recording a first operation duration of the first operation; when the first operation duration is greater than a first preset duration, displaying a pre-selection mark in an object area corresponding to the initial lock virtual object, wherein the pre-selection mark indicates that a virtual object with the pre-selection mark is the object currently switched to; switching the plurality of virtual objects in sequence according to the first switching order with the initial lock virtual object as the starting point, determining, from the plurality of virtual objects, a first switching object corresponding to the first drag distance of the drag operation, and displaying the pre-selection mark in an object area corresponding to the first switching object.

In some embodiments, the computer-readable storage medium is further configured to store a program code for performing the following steps: determining a position of a central axis of the first touch area to obtain a first position; determining a current position after a touch medium drags the first touch area to obtain a second position; and determining the first drag distance based on a distance between the first position and the second position.

In some embodiments, the computer-readable storage medium is further configured to store a program code for performing the following steps: determining an initial position when the touch medium performs a drag operation on the first touch area on the graphical user interface to obtain a first position; determining a current position after the touch medium drags the first touch area to obtain a second position; and determining the first drag distance based on a distance between the first position and the second position.

In some embodiments the computer-readable storage medium is also configured to store a program code for performing the following steps: mapping the position information of the plurality of virtual objects in the graphical user interface onto a preset direction to obtain mapping positions corresponding to the plurality of virtual objects; and determining the first switching order for switching the plurality of virtual objects based on the mapping positions corresponding to the plurality of virtual objects and an initial mapping position of the initial lock virtual object.

In some embodiments, the computer-readable storage medium is further configured to store a program cod for performing the following steps: when it is detected that mapping positions of at least two virtual objects are the same, determining object distances between the at least two virtual objects and a target virtual object; and determining a switching order of the at least two virtual objects according to the object distances.

In some embodiments, the computer-readable storage medium is further configured to store a program code for performing the following steps: when a change in the position of a first virtual object in the graphical user interface is detected, updating a mapping position of the first virtual object in the preset direction, and updating the first switching order based on the mapping position of the first virtual object, where the first virtual object is any one of the plurality of virtual objects.

In some embodiments, the computer-readable storage medium is also configured to store a program code for performing the following steps: displaying a pre-selection mark in an object area corresponding to the initial lock virtual object; and displaying a pre-selection mark in an object area corresponding to a next object when the first drag distance is greater than a first distance threshold, where the next object is a next switching object corresponding to the first switching object in the first switching order.

In some embodiments, the computer-readable storage medium is further configured to store a program code for performing the following steps: determining a drag direction corresponding to the drag operation; determining a movement distance corresponding to the pre-selection mark based on the first drag distance, wherein the movement distance is the distance that the pre-selection mark moves within an object area corresponding to the current lock virtual object according to the drag direction; when the movement distance is greater than a second distance threshold, controlling the pre-selection mark to stop moving, where the second distance threshold is smaller than the first distance threshold.

In some embodiments, the computer-readable storage medium is further configured to store a program code for performing the following step: displaying object information of the first switching object in the information display area, wherein the content displayed by the graphical user interface further includes an information display area.

In some embodiments, the above-mentioned computer-readable storage medium is also configured to store a program code for performing the following steps: detecting whether the target object has a plurality of areas to be switched; when the target object has a plurality of areas to be switched, displaying a preset mark at a second touch area in the graphical user interface, and responding to a second operation on the first touch area, where the preset mark represents that the first switching object has a plurality of areas to be switched; when the operation duration of the second operation is greater than a second preset duration, displaying corresponding area marks in the plurality of areas to be switched, and displaying area information of the plurality of areas to be switched in the information display area.

In some embodiments, the computer-readable storage medium is also configured to store a program code for performing the following steps: in response to a drag operation on the first touch area, performing switching of the plurality of areas to be switched in sequence according to a second switching order, and determining a current switching area corresponding to a second drag distance, wherein the second drag distance is the current drag distance of the drag operation on the first touch area; in response to a release operation on the first touch area, determining that the current switching area is a target area corresponding to the target object.

In some embodiments, the computer-readable storage medium is also configured to store a program code for performing the following steps: when the target object has a plurality of areas to be switched, in response to a drag operation on the first touch area in a first direction, drag the first touch area to the position of the second touch area so that the first touch area at least partially overlaps with the second touch area; in response to a drag operation on the first touch area in a second direction, performing switching of the plurality of virtual objects in sequence according to the first switching order, where the first direction is different from the second direction.

Through the description of the above implementations, it is easy for those skilled in the art to understand that the example implementations described here can be implemented by software, or by software combined with necessary hardware. Therefore, the technical solutions according to the implementations of the present disclosure can be embodied in the form of a software product. The software product can be stored in a computer-readable storage medium (which can be a CD-ROM, a U disk, a mobile hard disk, etc.) or the software product can be stored on a network, including a number of instructions to enable a computing device (which can be a personal computer, a server, a terminal device, or a network device, etc.) to perform the methods according to the implementations of the present disclosure.

In an example embodiment of the present disclosure, a program product capable of implementing the above methods of the embodiments is stored on a computer-readable storage medium. In some implementations, various aspects of the embodiments of the present disclosure may also be implemented in the form of a program product, which includes a program code. When the program product is run on a terminal device, the program code is configured to enable the terminal device to implement the steps according to various example method implementations of the present disclosure.

The program product for implementing the above methods in the embodiments of the present disclosure may adopt a portable Compact Disk Read-Only Memory (CD-ROM) and include a program code, and can be run on a terminal device, such as a personal computer. However, the program product of the embodiment of the present disclosure is not limited to this. In an embodiment of the present disclosure, the computer-readable storage medium can be any tangible medium containing or storing a program, and the program can be used by or in combination with an instruction execution system, apparatus or device.

The program product may adopt any combination of one or more computer-readable mediums. The computer-readable storage medium may be, for example, but not limited to, an electrical, magnetic, optical, electromagnetic, infrared, or semiconductor system, apparatus or device, or any combination thereof. More specific examples (non-exhaustive enumeration) of the computer-readable storage medium include: an electrical connection with one or more wires, a portable disk, a hard disk, a Random Access Memory (RAM), a Read-Only Memory (ROM), an Erasable Programmable Read-Only Memory (EPROM or a flash memory), an optical fiber, a portable Compact Disk Read-Only Memory (CD-ROM), an optical storage device, a magnetic storage device, or any suitable combination thereof.

It should be noted that the program code included in the computer-readable storage medium may be transmitted using any appropriate medium, including but not limited to wireless, wired, an optical cable, RF, etc., or any suitable combination of the above.

An embodiment of the present disclosure further provides an electronic apparatus, including a memory and a processor. A computer program is stored in the memory, and the processor is configured to run the computer program to perform the steps in any one of the above method embodiments.

In some embodiments, the electronic apparatus may further include a transmission device and an input/output device. The transmission device is connected to the processor, and the input/output device is connected to the processor.

In some embodiments, the processor may be configured to perform the following steps through the computer program: determining an initial lock virtual object from a plurality of virtual objects; in response to a drag operation on a first touch area in the graphical user interface, according to an operation parameter of the drag operation, determining a first switching object from the plurality of virtual objects according to a first switching order with the initial lock virtual object as a starting point; and in response to a release operation on the first touch area, determining the first switching object to be a target object.

In some embodiments, the processor may be further configured to perform the following steps through the computer program: determining the initial lock virtual object from the plurality of virtual objects according to position information of the plurality of virtual objects in the graphical user interface.

In some embodiments, the processor may be further configured to perform the following steps through the computer program: in response to a first operation on the first touch area, recording a first operation duration of the first operation; when the first operation duration is greater than a first preset duration, displaying a pre-selection mark in an object area corresponding to the initial lock virtual object, wherein the pre-selection mark indicates that a virtual object with the pre-selection mark is an object currently switched to; and according to the first switching order, performing switching of the plurality of virtual objects in sequence with the initial lock virtual object as the starting point, and determining, from the plurality of virtual objects, the first switching object corresponding to a first drag distance of the drag operation, and displaying the pre-selection mark in an object area corresponding to the first switching object.

In some embodiments, the processor may be further configured to perform the following steps through the computer program: determining a position of a central axis of the first touch control area to obtain a first position; determining a current position after dragging of the first touch area by a touch medium to obtain a second position; and determining the first drag distance according to a distance between the first position and the second position.

In some embodiments, the processor may be further configured to perform the following steps through the computer program: determining an initial position when a touch medium performs the drag operation on the first touch area on the graphical user interface to obtain a first position; determining a current position after dragging of the first touch area by a touch medium to obtain a second position; and determining the first drag distance according to a distance between the first position and the second position.

In some embodiments, the processor may be further configured to perform the following steps through the computer program: mapping position information of the plurality of virtual objects in the graphical user interface onto a preset direction to obtain mapping positions corresponding to the plurality of virtual objects; and determining the first switching order for switching of the plurality of virtual objects according to the mapping positions corresponding to the plurality of virtual objects and an initial mapping position of the initial lock virtual object.

In some embodiments, the processor may be further configured to perform the following steps through the computer program: when it is detected that mapping positions of at least two virtual objects are the same, determining object distances between the at least two virtual objects and a target virtual object; and determining a switching order of the at least two virtual objects according to the object distances.

In some embodiments, the processor may be further configured to perform the following steps through the computer program: when a change in a position of a first virtual object in the graphical user interface is detected, updating a mapping position of the first virtual object in the preset direction, and updating the first switching order based on the mapping position of the first virtual object, wherein the first virtual object is any one of the plurality of virtual objects.

In some embodiments, the processor may be further configured to perform the following steps through the computer program: displaying the pre-selection mark in the object area corresponding to the initial lock virtual object; and when the first drag distance is greater than a first distance threshold, displaying the pre-selection mark in an object area corresponding to a next object, wherein the next object is a next switching object corresponding to the first switching object in the first switching order.

In some embodiments, the processor may be further configured to perform the following steps through the computer program: determining a drag direction corresponding to the drag operation; determining a movement distance corresponding to the pre-selection mark according to the first drag distance, wherein the movement distance is a distance that the pre-selection mark moves in an object area corresponding to a current lock virtual object according to the drag direction; and when the movement distance is greater than a second distance threshold, controlling the pre-selection mark to stop moving, wherein the second distance threshold is smaller than the first distance threshold.

In some embodiments, the processor may be configured to perform the following steps through the computer program: displaying object information of the first switching object in an information display area. The content displayed by the graphical user interface further includes: the information display area.

In some embodiments, the processor may be further configured to perform the following steps through the computer program: detecting whether the target object has a plurality of areas to be switched; when the target object has the plurality of areas to be switched, displaying a preset mark at a second touch area in the graphical user interface, and responding to a second operation on the first touch area, wherein the preset mark indicates that the first switching object has the plurality of areas to be switched; and when an operation duration of the second operation is greater than a second preset duration, displaying corresponding area marks in the plurality of areas to be switched, and displaying area information of the plurality of areas to be switched in the information display area.

In some embodiments, the processor may be further configured to perform the following steps through the computer program: in response to a drag operation on the first touch area, performing switching of the plurality of areas to be switched in sequence according to a second switching order, and determining a current switching area corresponding to a second drag distance, wherein the second drag distance is a current drag distance of the drag operation on the first touch area; and in response to a release operation on the first touch area, determining the current switching area to be a target area corresponding to the target object.

In some embodiments, the processor may be further configured to perform the following steps through the computer program: when the target object has a plurality of areas to be switched, in response to a drag operation on the first touch area in a first direction, dragging the first touch area to a position of the second touch area to make the first touch area at least partially overlap with the second touch area; and in response to a drag operation on the first touch area in a second direction, performing switching of the plurality of virtual objects in sequence according to the first switching order, wherein the first direction is different from the second direction.

In at least some embodiments of the present disclosure, object switching is implemented by a drag operation on a switching control. An initial lock virtual object is determined from multiple virtual objects displayed in a graphical user interface, and in response to a drag operation on a first touch area located in the graphical user interface, according to an operation parameter of the drag operation, a first switching object is determined from the multiple virtual objects according to a first switching order with the initial lock virtual object as a starting point. And, in response to a release operation on the first touch area, the first switching object is determined as a target object.

In the above procedure, a player can determine the target object from multiple virtual objects by dragging the first touch area. It can be seen that in the technical solution of the present disclosure, the player can autonomously choose to perform switching between multiple virtual objects, thereby achieving the purpose of the player autonomously selecting a virtual object. In addition, in the present disclosure, switching of multiple virtual objects is performed according to a certain switching order. Therefore, before completing the switching of multiple virtual objects, the player can foresee the next virtual object to be switched to, thereby avoiding the problem in related art that the player cannot foresee the virtual object to be switched to. In addition, in the procedure of switching multiple virtual objects, the multiple virtual objects are switched according to a certain switching order. That is, in the procedure of switching multiple virtual objects, each virtual object may be switched to, thereby avoiding the problem in related art that accurate switching cannot be realized due to large number of virtual objects and/or dense positions. Thus, the embodiments of the present disclosure can achieve accurate switching of virtual objects.

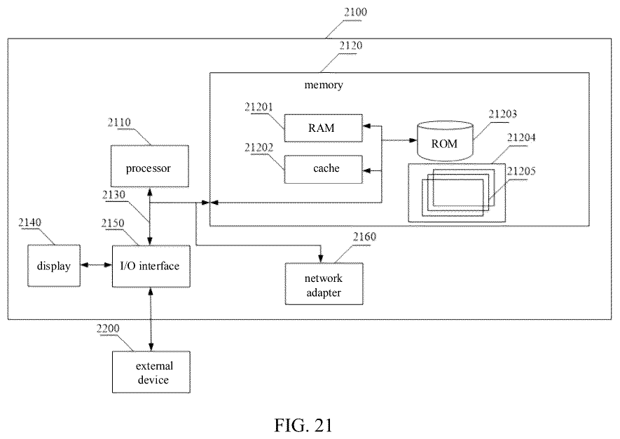

FIG. 21 is a schematic diagram of an electronic apparatus according to an embodiment of the present disclosure. As shown in FIG. 21, the electronic apparatus 2100 is only an example and should not impose any limitation to the functions and range of application of the embodiments of the present disclosure.

As shown in FIG. 21, the electronic apparatus 2100 is presented in the form of a general-purpose computing device. The components of the electronic apparatus 2100 may include, but are not limited to: the at least one processor 2110, the at least one memory 2120, a bus 2130 connecting different system components (including the memory 2120 and the processor 2110), and a display 2140.

The memory 2120 stores program codes, which can be executed by the processor 2110, so that the processor 2110 performs the steps according to various example embodiments of the present disclosure as described in the part for describing the method embodiments of the present disclosure.

The memory 2120 may include a readable medium in the form of a volatile storage unit, such as a Random Access Memory (RAM) unit 21201 and/or a cache memory unit 21202, and may further include a Read-Only Memory (ROM) unit 21203, and may further include a non-volatile memory, such as one or more magnetic storage devices, flash memories, or other non-volatile solid-state memories.

In some examples, the memory 2120 may further include a program/utility tool 21204 having a set (at least one) of program modules 21205. Such program modules 21205 include but not limited to: an operating system, one or more application programs, other program modules, and program data. Each of the examples or a combination of the examples may include implementation of a network environment. The memory 2120 may further include memory (memories) remotely arranged relative to the processor 2110, and remote memories may be connected to the electronic apparatus 2100 via a network. Examples of the network include but are not limited to the Internet, an intranet, a local area network, a mobile communication network, and a combination thereof.

The bus 2130 may represent one or more of several types of bus structures, including a memory unit bus or memory unit controller, a peripheral bus, an accelerated graphics port, a processor 2110 or a local bus using any of a variety of bus structures.

The display 2140 may be, for example, a touch screen type Liquid Crystal Display (LCD), which may enable a user to interact with a user interface of the electronic apparatus 2100.

In some embodiments, the electronic apparatus 2100 may also communicate with one or more external devices 2200 (such as a keyboard, a pointing device, a Bluetooth device, etc.), and may also communicate with one or more devices that enable a user to interact with the electronic apparatus 2100, and/or may also communicate with any device (such as a router, a modem) that can enable the electronic apparatus 2100 to interact with one or more other computing devices. Such communication can be performed through an input/output (I/O) interface 2150. Moreover, the electronic apparatus 2100 may also communicate with one or more networks (such as a local area network (LAN), a wide area network (WAN), and/or a public network, such as the Internet) through the network adapter 2160. As shown in FIG. 21, the network adapter 2160 communicates with other modules of the electronic apparatus 2100 through the bus 2130. It should be understood that although not shown in FIG. 21, other hardware and/or software modules may be used in conjunction with the electronic apparatus 2100, including but not limited to: microcode, device drivers, redundant processing units, external disk drive arrays, RAID systems, tape drives and data backup storage systems.

The electronic apparatus 2100 may further include: a keyboard, a cursor control device (such as a mouse), an input/output interface (I/O interface), a network interface, a power supply and/or a camera.

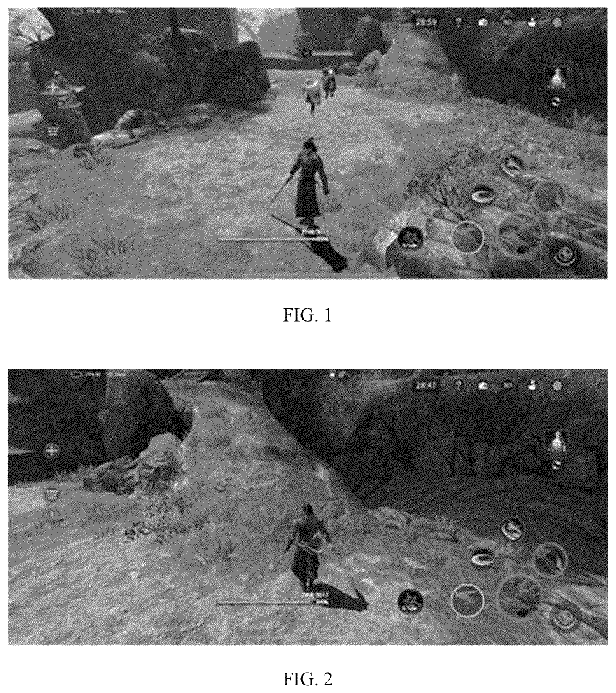

It will be understood by those skilled in the art that the structure shown in FIG. 21 is for illustration only and does not limit the structure of the electronic apparatus described above. For example, the electronic apparatus 2100 may include more or fewer components than those shown in FIG. 21, or have a configuration different from that shown in FIG. 1. The memory 2120 may be configured to store computer programs and corresponding data, such as the computer programs and corresponding data corresponding to the virtual object switching methods in the embodiments of the present disclosure. The processor 2110 executes various functional applications and data processing by running the computer programs stored in the memory 2120, that is, to implement the virtual object switching methods described above.

The serial numbers of the above-mentioned embodiments of the present disclosure are only for description and do not represent advantages or disadvantages of the embodiments.

In the above embodiments of the present disclosure, the description of each embodiment has its own emphasis. For parts that are not described in detail in a certain embodiment, reference can be made to relevant descriptions of other embodiments.

In the several embodiments provided in the present disclosure, it should be understood that the disclosed technical content can be implemented in other ways. The apparatus embodiments described above are only illustrative. For example, the division of units can be a logical function division. There may be other division methods in actual implementations. For example, a plurality of units or components can be combined or integrated into another system, or some features can be ignored or not executed. Another point is that the mutual coupling or direct coupling or communication connection shown or discussed can be through some interfaces, indirect coupling or communication connection of units or modules, which can be electrical or other forms.

The units described as separate components may or may not be physically separated, and the components shown as units may or may not be physical units, that is, they may be located in one place or distributed over a plurality of units. Some or all of the units may be selected according to actual needs to achieve the purposes of embodiments of the present disclosure.

In addition, various functional units in embodiments of the present disclosure may be integrated into one processing unit, or various units may exist physically and separately, or two or more units may be integrated into one unit. The integrated unit may be implemented in the form of hardware or in the form of software functional unit(s).

If the integrated unit is implemented in the form of a software functional unit and sold or used as an independent product, it can be stored in a computer-readable storage medium. Based on this understanding, the technical solutions of the present disclosure, or the part that contributes to the related art, or all or part of the technical solutions can be embodied in the form of a software product. The computer software product is stored in a storage medium, including a number of instructions to enable a computer device (which can be a personal computer, a server or a network device, etc.) to perform all or part of the steps of the methods described in the embodiments of the present disclosure. The storage medium includes various mediums that can store program codes, such as, a U disk, a Read-Only Memory (ROM), a Random Access Memory (RAM), a mobile hard disk, a magnetic disk or an optical disk, etc.

The above only describes example embodiments of the present disclosure. It should be pointed out that for those of ordinary skill in this art, improvements and modifications can be made without departing from the principle of the present disclosure. These improvements and modifications should also be regarded as falling within the scope of protection of the present disclosure.

1. A virtual object switching method, comprising:
determining an initial lock virtual object from a plurality of virtual objects in a game scene comprised in a graphical user interface provided by a terminal device;
in response to a drag operation on a first touch area in the graphical user interface, according to an operation parameter of the drag operation, determining a first switching object from the plurality of virtual objects according to a first switching order with the initial lock virtual object as a starting point; and
in response to a release operation on the first touch area, determining the first switching object to be a target object.

2. The method according to claim 1, wherein determining the initial lock virtual object from the plurality of virtual objects comprises:
determining the initial lock virtual object from the plurality of virtual objects according to position information of the plurality of virtual objects in the graphical user interface.

3. The method according to claim 2, wherein the operation parameter of the drag operation comprises a first drag distance;
wherein determining the first switching object comprises:
in response to a first operation on the first touch area, recording a first operation duration of the first operation;
in response to the first operation duration being greater than a first preset duration, displaying a pre-selection mark in an object area corresponding to the initial lock virtual object, wherein the pre-selection mark indicates that a virtual object with the pre-selection mark is an object currently switched to; and
according to the first switching order, performing switching of the plurality of virtual objects in sequence with the initial lock virtual object as the starting point, and determining, from the plurality of virtual objects, the first switching object corresponding to the first drag distance of the drag operation, and displaying the pre-selection mark in an object area corresponding to the first switching object.

4. The method according to claim 3, further comprising:
determining a position of a central axis of the first touch control area to obtain a first position;
determining a current position of the central axis after a touch medium drags the first touch area to obtain a second position; and
determining the first drag distance according to a distance between the first position and the second position.

5. The method according to claim 3, further comprising:
determining an initial touch position where a touch medium performs the drag operation on the first touch area on the graphical user interface to obtain a first position;
determining a current touch position of the touch medium after the touch medium drags the first touch area to obtain a second position; and
determining the first drag distance according to a distance between the first position and the second position.

6. The method according to claim 3, further comprising:
mapping position information of the plurality of virtual objects in the graphical user interface onto a preset direction to obtain mapping positions corresponding to the plurality of virtual objects; and
determining the first switching order for switching of the plurality of virtual objects according to the mapping positions corresponding to the plurality of virtual objects and an initial mapping position of the initial lock virtual object.

7. The method according to claim 6, further comprising:
in response to detecting that mapping positions of at least two virtual objects are the same, determining object distances between the at least two virtual objects and a target virtual object; and
determining a switching order of the at least two virtual objects according to the object distances.

8. The method according to claim 6, further comprising:
in response to a change in a position of a first virtual object in the graphical user interface being detected, updating a mapping position of the first virtual object in the preset direction, and updating the first switching order based on the mapping position of the first virtual object, wherein the first virtual object is any one of the plurality of virtual objects.

9. The method according to claim 6, wherein determining, from the plurality of virtual objects, the first switching object corresponding to the first drag distance of the drag operation comprises:
displaying the pre-selection mark in the object area corresponding to the initial lock virtual object; and
in response to the first drag distance being greater than a first distance threshold, displaying the pre-selection mark in an object area corresponding to a next object, wherein the next object is a next switching object following the first switching object in the first switching order.

10. The method according to claim 9, further comprising:
determining a drag direction corresponding to the drag operation;
determining a movement distance corresponding to the pre-selection mark according to the first drag distance, wherein the movement distance is a distance that the pre-selection mark moves in an object area corresponding to a current lock virtual object according to the drag direction; and
in response to the movement distance being greater than a second distance threshold, controlling the pre-selection mark to stop moving, wherein the second distance threshold is smaller than the first distance threshold.

11. The method according to claim 9, wherein the content displayed by the graphical user interface further comprises an information display area, and the method further comprises:
displaying object information of the first switching object in the information display area.

12. The method according to claim 11, further comprising:
detecting whether the target object has a plurality of areas to be switched;
in response to the target object comprising the plurality of areas to be switched, displaying a preset mark at a second touch area in the graphical user interface, and responding to a second operation on the first touch area, wherein the preset mark indicates that the first switching object has the plurality of areas to be switched; and
in response to an operation duration of the second operation being greater than a second preset duration, displaying corresponding area marks in the plurality of areas to be switched, and displaying area information of the plurality of areas to be switched in the information display area.

13. The method according to claim 12, further comprising:
in response to a drag operation on the first touch area, performing switching of the plurality of areas to be switched in sequence according to a second switching order, and determining a current area corresponding to a second drag distance, wherein the second drag distance is a current drag distance of the drag operation on the first touch area; and
in response to a release operation on the first touch area, determining the current area to be a target area corresponding to the target object.

14. The method according to claim 12, further comprising:
in response to the target object comprising the plurality of areas to be switched, and in response to a drag operation on the first touch area in a first direction, dragging the first touch area to a position of the second touch area to make the first touch area at least partially overlap with the second touch area; and
in response to a drag operation on the first touch area in a second direction, performing switching of the plurality of virtual objects in sequence according to the first switching order, wherein the first direction is different from the second direction.

15. (canceled)

16. A non-transitory computer-readable storage medium, wherein a computer program is stored in the computer-readable storage medium, and when the computer program is run by a processor, the processor is configured to:
determine an initial lock virtual object from a plurality of virtual objects displayed in a graphical user interface provided by a terminal device;
in response to a drag operation on a first touch area in the graphical user interface, according to an operation parameter of the drag operation, determine a first switching object from the plurality of virtual objects according to a first switching order with the initial lock virtual object as a starting point; and
in response to a release operation on the first touch area, determine the first switching object to be a target object.

17. An electronic apparatus comprising a memory and a processor, wherein the memory stores a computer program, and the processor is configured to run the computer program to;
determine an initial lock virtual object from a plurality of virtual objects displayed in a graphical user interface;
in response to a drag operation on a first touch area in the graphical user interface, according to an operation parameter of the drag operation, determine a first switching object from the plurality of virtual objects according to a first switching order with the initial lock virtual object as a starting point; and
in response to a release operation on the first touch area, determine the first switching object to be a target object.

18. The method according to claim 13, wherein the current area, which is currently switched to according to the second switching order, is highlighted in the information display area.

19. The method according to claim 13, wherein the second switching order is determined according to area marks corresponding to the plurality of areas to be switched.

20. The method according to claim 14, further comprising:
in response to first touch area partially overlapping with the second touch area, presenting the graphical user interface in which the area marks are invisible.

21. The electronic apparatus according to claim 17, wherein the processor is configured to run the computer program to:
in response to a first operation on the first touch area, record a first operation duration of the first operation;
in response to the first operation duration being greater than a first preset duration, displaying a pre-selection mark in an object area corresponding to the initial lock virtual object, wherein the pre-selection mark indicates that a virtual object with the pre-selection mark is an object currently switched to; and
according to the first switching order, performing switching of the multiple virtual objects in sequence with the initial lock virtual object as the starting point, and determining, from the multiple virtual objects, the first switching object corresponding to the first drag distance of the drag operation, and displaying the pre-selection mark in an object area corresponding to the first switching object.
